(19) United States
(12) Patent Application Publication
(10) Pub. No.: US 2026/0322111 A1
(43) Pub. Date: Oct. 15, 2026

(54) GAS DISCHARGE TUBE-BASED SURGE PROTECTION SYSTEM

(71) Applicant: viaPhoton LLC, Naperville, IL (US)

(72) Inventor: Steve FISCHER, Windsor, CO (US)

(21) Appl. No.: 19/643,530

(22) Filed: Apr. 9, 2026

Related U.S. Application Data
(60) Provisional application No. 63/785,747, filed on Apr. 9, 2025.
(60) Provisional application No. 63/792,758, filed on Apr. 22, 2025.

(51) Int. Cl. H02H 9/06; H01T 2/02; H01T 15/00; H02H 9/00; H02H 9/04

(52) U.S. Cl. CPC H02H 9/06; H01T 2/02; H01T 15/00; H02H 9/005; H02H 9/045

(57) ABSTRACT

A surge protection apparatus, system, and method are disclosed for protecting an electrical load from transient overvoltage conditions. The apparatus may include first and second conductor paths extending from an input side toward an output side, inductive elements disposed in the conductor paths, a trigger network coupled to the conductor paths, and one or more gas discharge tubes coupled to the conductor paths and a reference node. The inductive elements delay propagation of surge energy, and the trigger network applies a trigger to the one or more gas discharge tubes such that the gas discharge tubes are pre-ionized before a main surge current reaches the output side. In further embodiments, multiple gas discharge tubes, resistor-capacitor networks, and metal oxide varistors cooperate to suppress line-to-line and line-to-ground surge conditions.

### CROSS REFERENCE TO RELATED APPLICATIONS

This Application claims the benefit of U.S. Provisional Application Serial No. 63/785,747, filed Apr. 9, 2025, and .S. Provisional Application Serial No. 63/792,758, filed Apr. 22, 2025, both of which is hereby incorporated by reference for all purposes.

### BACKGROUND

Electrical systems that power radios, communications equipment, network hardware, and other field-deployed loads are routinely exposed to transient overvoltage conditions. Such conditions may arise from lightning strikes, inductive switching events, ground potential differences, or other disturbances coupled onto power conductors. Surge protection devices are commonly used in these environments to reduce the magnitude of transient energy presented to protected equipment, particularly where the equipment is remote, exposed to outdoor infrastructure, or otherwise connected to conductors that can carry fast-rising surge currents.

Conventional surge suppression arrangements often rely on gas discharge tubes and metal oxide varistors to manage transient events having different magnitudes and durations. Gas discharge tubes can be effective for shunting high-energy events, but their operating behavior presents design challenges because the voltage required to initiate ionization may be materially higher than the voltage sustained after conduction begins. Fast transient events, including lightning-related pulses, may therefore reach sensitive circuitry before a gas discharge tube fully transitions into conduction. This timing issue can complicate protection design, particularly where a short-duration surge must be intercepted before the protected load experiences an excessive voltage excursion.

Additional challenges arise because surge events may occur in different modes and under different grounding conditions. Some systems must tolerate both conductor-to-conductor transients and conductor-to-ground transients, and some loads are used in installations in which neither power conductor is permanently tied to ground. In practice, smaller repetitive surges may be addressed by varistor-based devices, while larger events can exceed the practical handling capability of those devices alone. As a result, designers continue to seek surge protection architectures that provide reliable protection across differing surge magnitudes, pulse shapes, and grounding topologies without imposing undue stress on the protected equipment. ….

### SUMMARY

In one aspect, a surge protection apparatus is provided for protecting an electrical load using first and second conductor paths that extend from an input side toward an output side, inductive elements disposed in the conductor paths, a trigger network coupled to the conductor paths, and one or more gas discharge tubes coupled to the conductor paths and a reference node. The inductive elements delay propagation of surge energy toward the output side, while the trigger network responds to a surge event and applies a trigger to the gas discharge tube path so that the gas discharge tubes are pre-ionized before a main surge current reaches the output side. In some embodiments, the apparatus may further include trigger coils, a floating-ground arrangement, and coordinated operation with one or more metal oxide varistors.

In another aspect, a method of surge protection is provided in which a surge event is detected on first and second conductor paths associated with an electrical load, surge energy is delayed along the conductor paths, and a trigger is applied to one or more gas discharge tubes before a main surge current reaches the protected side of the circuit. The method further includes conducting at least a portion of the main surge current through the gas discharge tube path to suppress line-to-line surge conditions and line-to-ground surge conditions. In some embodiments, the method may include detecting the surge event with trigger coils, coupling surge energy through a capacitor and transformer arrangement, and coordinating operation between the gas discharge tubes and one or more metal oxide varistors for different surge magnitudes.

In a further aspect, a surge protection apparatus is provided with a line conductor path, a return conductor path, a first gas discharge tube coupled to the line conductor path, the return conductor path, and a central node, a second gas discharge tube coupled to the line conductor path, the central node, and ground, and a third gas discharge tube coupled to the return conductor path, the central node, and ground. The apparatus further includes inductive elements in the line and return conductor paths, resistor-capacitor networks coupled between the respective conductor paths and the central node, and metal oxide varistors coupled between the respective conductor paths and ground. The resistor-capacitor networks develop a transient voltage at the central node in response to a surge event, and the gas discharge tubes conduct surge current for both line-to-line and line-to-ground surge conditions. In some embodiments, an additional metal oxide varistor may be coupled between the line conductor path and the return conductor path. Other aspects of the invention will be apparent from the following description and the appended claims.

### BRIEF DESCRIPTION OF DRAWINGS

Based on the current figure set, including the boilerplate context figure, the circuit schematics, and the method flowchart, the following Brief Description of the Drawings is supported by the uploaded materials.

FIG. 1 shows an example cell site deployment environment for a surge protection system according to illustrative embodiments.

FIG. 2 shows a schematic circuit diagram of an example surge protection apparatus according to illustrative embodiments.

FIG. 3 shows a schematic circuit diagram of another example surge protection apparatus according to illustrative embodiments.

FIG. 4 shows a schematic circuit diagram of a further surge protection apparatus according to illustrative embodiments.

FIG. 5 shows a schematic circuit diagram of another example surge protection apparatus according to illustrative embodiments.

FIG. 6 shows a flowchart of an example method of surge according to illustrative embodiments.

Like elements in the various figures are denoted by like reference numerals for consistency.

### DETAILED DESCRIPTION

The present disclosure relates to a surge protection system that addresses the operating characteristics of gas discharge tubes in circuits exposed to fast-rising transient events. In particular, the disclosed subject matter recognizes that a gas discharge tube typically requires a higher voltage to initiate ionization than the lower voltage at which the tube subsequently clamps once conduction begins. In environments such as radio power systems and other field-deployed electrical loads, that disparity can permit a short-duration surge to advance toward protected equipment before the gas discharge tube has fully entered conduction. The disclosed system addresses that condition by using a surge path architecture in which incoming surge energy is delayed along primary conductor paths while a trigger network responds to the transient and prepares the gas discharge tube conduction path in advance.

In one group of embodiments, the system includes conductor paths extending between an input side and an output side, inductive elements disposed in the conductor paths, and a trigger network coupled to the conductor paths and to one or more gas discharge tubes. The inductive elements function as speed coils that retard propagation of the main surge front, while the trigger network detects the surge condition and applies a trigger to the gas discharge tubes so that the gas discharge tubes are pre-ionized before the delayed surge current reaches the protected side of the circuit. In this manner, the gas discharge tube path may engage within a tighter effective operating window, thereby reducing the voltage excursion experienced by the protected load. In some implementations, the trigger network may include trigger coils, capacitive coupling, a spark gap, and a transformer arrangement, and the system may operate in a floating-ground configuration in which neither conductor is permanently tied to ground at the load.

In another group of embodiments, the disclosure provides multi-device surge suppression arrangements in which multiple gas discharge tubes are coupled relative to line, return, central-node, and ground locations so that surge current may be diverted for both line-to-line and line-to-ground conditions. One or more resistor-capacitor networks may develop a transient at a central node to assist earlier gas-tube conduction, while metal oxide varistors may provide supplemental suppression paths for lower-magnitude or repetitive transient events and may cooperate with the gas discharge tubes during higher-energy surge events. The resulting arrangements improve coordination between delayed surge propagation, triggered gas-tube conduction, and parallel varistor-based suppression, thereby expanding the range of surge conditions that can be managed within a single protection architecture.

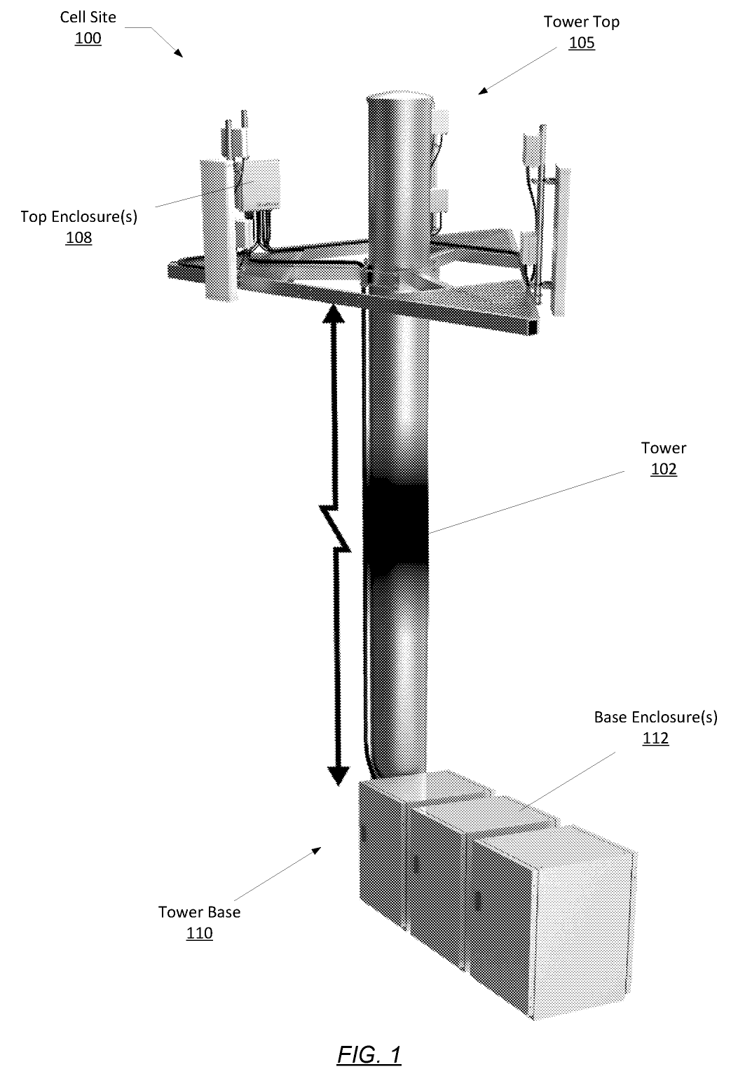

Referring now to FIG. 1, a cell site (100) includes an installation environment in which surge protection devices are deployed at physically separated locations and are coupled by cabling routed along a tower. In the illustrated arrangement, at least a portion of the protected conductor paths extend between equipment located proximate to a tower top (105) and equipment located proximately to a tower base (110), such that surge suppression and monitoring functions may be distributed across the site.

A tower (102) supports tower-top equipment and provides a routing structure for conductor paths extending between the tower top (105) and the tower base (110). In use, the tower (102) carries one or more conductor runs routed downward from the tower top (105) toward the tower base (110), and the conductor runs may serve as both protected conductors and as a conductive medium through which operating state information for surge protection devices can be interrogated and observed from a remote location.

The tower top (105) represents a tower-mounted region of the cell site (100) at which equipment and enclosures are positioned in proximity to radio hardware. In the illustrated arrangement, the tower top (105) is associated with one or more elevated mounting structures and conductor routing features, and cabling is shown routed between multiple tower-top devices and toward the tower (102) for descent to the tower base (110).

One or more top enclosures (108) are positioned at or proximate the tower top (105) and define an enclosed volume for housing tower-top components associated with protected conductor paths. In some embodiments, at least one top enclosure (108) houses a tower-top surge protection device (TT-SPD) that is coupled to one or more conductor paths routed between tower-top equipment and tower-base equipment. The top enclosure(s) (108) provides an interface location at which conductor paths enter and exit the enclosure, and the conductor paths are routed from the enclosure toward the tower (102) for descent to the tower base (110).

The tower base (110) represents a ground-level region of the cell site (100) at which equipment cabinets and enclosures are positioned and at which tower-routed cabling terminates or is redistributed. In use, conductor paths routed down the tower (102) from the tower top (105) are received proximate to the tower base (110) and may be coupled to additional equipment, including base-located surge protection devices and monitoring components.

One or more base enclosures (112) are positioned at or proximate the tower base (110) and define an enclosed volume for housing base-located components associated with protected conductor paths. In some embodiments, at least one base enclosure (112) houses a tower-base surge protection device (TB-SPD) that is coupled to the same conductor path as a corresponding TT-SPD housed at the tower top (105), thereby providing distributed surge suppression along the tower-routed conductor run.

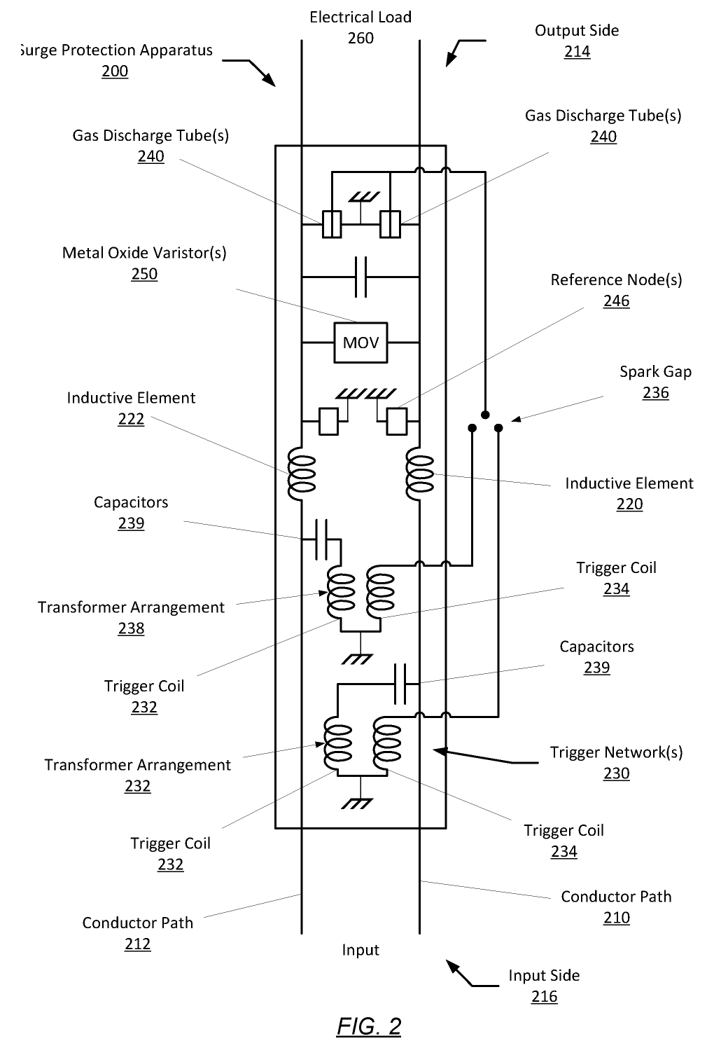

Referring now to FIG. 2, a surge protection apparatus (200) is shown in schematic form. The surge protection apparatus (200) may be coupled between an input side (216) and an output side (214) associated with an electrical load (260), such as a radio or other protected equipment. In the illustrated embodiment, the surge protection apparatus (200) includes a first conductor path (210) and a second conductor path (212) that extend from the input side (216) toward the output side (214). FIG. 2 generally corresponds to the broad apparatus architecture in which surge energy is delayed on the conductor paths and one or more gas discharge tubes are triggered into a pre-ionized state before a main surge current reaches the protected load.

The first conductor path (210) and the second conductor path (212) may define line paths through which operating current is delivered during normal use and through which surge current may enter the apparatus (200) during a transient event. The output side (214) is shown as the side directed “to radio,” while the input side (216) is the side exposed to an incoming surge condition. In some implementations, the conductor paths (210, 212) may correspond to positive and negative feeds of a floating-ground power arrangement in which neither conductor is permanently tied to ground at the load.

A first inductive element (220) is disposed in the first conductor path (210), and a second inductive element (222) is disposed in the second conductor path (212). The inductive elements (220, 222) may be implemented as speed coils configured to impede rapid propagation of surge energy toward the output side (214). By delaying the forward edge of a surge, the inductive elements (220, 222) provide time for upstream triggering activity to occur before the main surge current reaches the protected equipment.

A trigger network (230) is coupled to the first conductor path (210) and the second conductor path (212). In the embodiment shown, the trigger network (230) may include a first trigger coil (232), a second trigger coil (234), a spark gap (236), a transformer arrangement trigger coil (232), (238), and one or more capacitors (239). The trigger network (230) is arranged to respond to a rapid surge event on either conductor path and to generate a trigger that is communicated toward the gas discharge tube path. In some embodiments, the capacitors (239) may be coupled in series with primary portions of the transformer arrangement (238) so that a rapid voltage change induces a triggering response irrespective of surge polarity.

One or more gas discharge tubes (240) are coupled with respect to the first conductor path (210), the second conductor) path (212), and a reference node (246). In the illustrated embodiment, the one or more gas discharge tubes (240) may be implemented as a plurality of gas discharge tube devices positioned to receive the trigger generated by the trigger network (230). The reference node (246) may be a floating reference within the apparatus (200) rather than a permanent chassis or earth ground connection at the protected load. Upon receipt of the trigger, the gas discharge tubes (240) may be pre-ionized so that the tubes are prepared to conduct when the delayed surge current reaches the discharge path.

One or more metal oxide varistors (250) may also be coupled to the first conductor path (210) and the second conductor path (212). In FIG. 2, the metal oxide varistor arrangement is shown schematically as part of the surge suppression network positioned relative to the conductor paths. The one or more metal oxide varistors (250) may suppress smaller or repetitive surge events, while the one or more gas discharge tubes (240) may conduct during larger surge events. In this manner, the apparatus (200) may provide coordinated surge suppression over different surge magnitudes.

During operation, a transient event arriving from the input side (216) may be sensed by the trigger network (230) before the full surge current reaches the output side (214). The first inductive element (220) and the second inductive element (222) delay the surge on the conductor paths (210, 212), while the trigger network (230) develops and transmits a trigger toward the one or more gas discharge tubes (240). The one or more gas discharge tubes (240) may therefore enter a pre-ionized condition before the main surge current arrives.

Once pre-ionized, the one or more gas discharge tubes (240) may conduct at least a portion of the surge current and thereby reduce the voltage presented at the output side (214). The illustrated arrangement may suppress both common-mode and differential-mode surge conditions, including line-to-line surges between the conductor paths (210, 212) and line-to-reference surges relative to the reference node (246). Although FIG. 2 shows one schematic arrangement, the number and placement of the gas discharge tubes (240), inductive elements (220, 222), triggering components of the trigger network (230), and metal oxide varistors (250) may be varied.

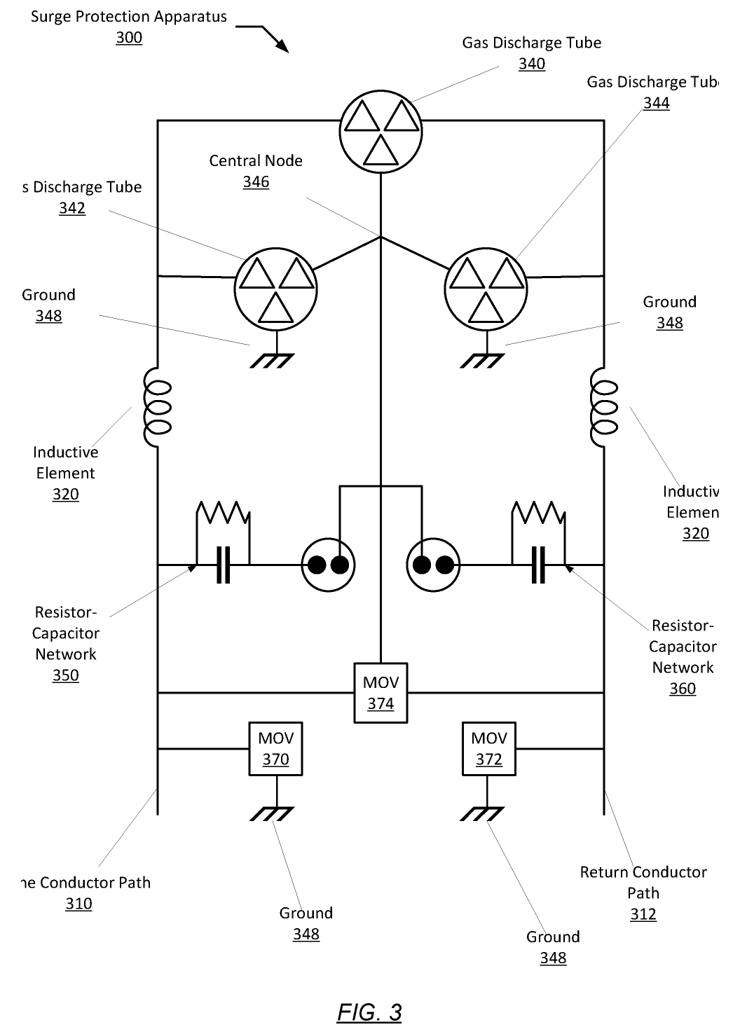

Referring now to FIG. 3, a surge protection apparatus (300) is shown in schematic form. The surge protection apparatus (300) may be coupled between an input side and an output side of a protected circuit and may include a line conductor path (310) and a return conductor path (312). The line conductor path (310) and the return conductor path (312) extend through the apparatus (300) and define conductive paths along which operating current may be delivered during normal operation and along which surge current may propagate during a transient event. FIG. 3 illustrates a multi-gas-tube arrangement in which surge current may be diverted in both conductor-to-conductor and conductor-to-ground conditions.

A first gas discharge tube (340) is coupled between the line conductor path (310) and the return conductor path (312) in an upper portion of the apparatus (300). The first gas discharge tube (340) may further be coupled to a central node (346). In this arrangement, the first gas discharge tube (340) may provide a discharge path for a line-to-line surge condition between the line conductor path (310) and the return conductor path (312), while also being responsive to a transient developed at the central node (346).

A second gas discharge tube (342) is coupled relative to the line conductor path (310), the central node (346), and ground (348). A third gas discharge tube (344) is coupled relative to the return conductor path (312), the central node (346), and ground (348). The second gas discharge tube (342) and the third gas discharge tube (344) may provide discharge paths for line-to-ground surge conditions originating on the respective conductor paths. The central node (346) is coupled to each of the first gas discharge tube (340), the second gas discharge tube (342), and the third gas discharge tube (344), so that a transient developed at the central node (346) may influence conduction of multiple gas discharge tubes within the apparatus (300).

A first inductive element (320) is disposed in the line conductor path (310), and a second inductive element (322) is disposed in the return conductor path (312). The inductive elements (320, 322) may be implemented as speed coils or other inductive devices configured to delay propagation of surge energy toward the protected side of the circuit. By impeding the leading edge of a surge, the inductive elements (320, 322) may permit a triggering action to develop before a larger portion of the surge current reaches downstream equipment. This delayed propagation arrangement is consistent with the disclosed use of speed coils to stall forward surge current while a gas discharge path is prepared for conduction.

A first resistor-capacitor network (350) is coupled between the line conductor path (310) and the central node (346). A second resistor-capacitor network (360) is coupled between the return conductor path (312) and the central node (346). In the illustrated example, each resistor-capacitor network (350, 360) may include a resistor and a capacitor. The resistor-capacitor networks (350, 360) may respond to a rapid voltage excursion on either conductor path and may develop a transient voltage at the central node (346). That transient voltage may initiate or assist conduction of one or more of the gas discharge tubes (340, 342, 344).

A first metal oxide varistor (370) may be coupled between the line conductor path (310) and ground (348). A second metal oxide varistor (372) may be coupled between the return conductor path (312) and ground (348). In the illustrated embodiment, an additional metal oxide varistor (374) is also shown in the lower portion of the apparatus (300) and may be coupled between the line conductor path (310) and the return conductor path (312). The metal oxide varistors (370, 372, 374) may suppress lower-magnitude or repetitive surge events and may further cooperate with the gas discharge tubes (340, 342, 344) during higher-energy surge events. The first metal oxide varistor (370) and the second metal oxide varistor (372) may provide clamping paths for conductor-to-ground surge conditions, while the third metal oxide varistor (380) may provide a clamping path for a conductor-to-conductor surge condition between the line conductor path (310) and the return conductor path (312).

During operation, a surge appearing on the line conductor path (310), the return conductor path (312), or both may be delayed by the inductive elements (320, 322). At substantially the same time, one or both of the resistor-capacitor networks (350, 360) may develop a transient at the central node (346). The transient at the central node (346) may place the gas discharge tubes (340, 342, 344) into a condition in which they are prepared to conduct before the main surge current fully reaches the protected side of the circuit. In this manner, the apparatus (300) may reduce the voltage presented to the protected load by causing the gas discharge tube network to respond within a narrower effective window.

The first gas discharge tube (340) may conduct for a line-to-line surge event between the line conductor path (310) and the return conductor path (312). The second gas discharge tube (342) and the third gas discharge tube (344) may conduct for respective line-to-ground surge events. The metal oxide varistors (370, 372, 374) may provide parallel suppression paths and may absorb or clamp lower-level transients that do not require full gas-tube conduction. FIG. 3 therefore illustrates a topology in which multiple discharge paths are available for differential-mode and common-mode surge conditions.

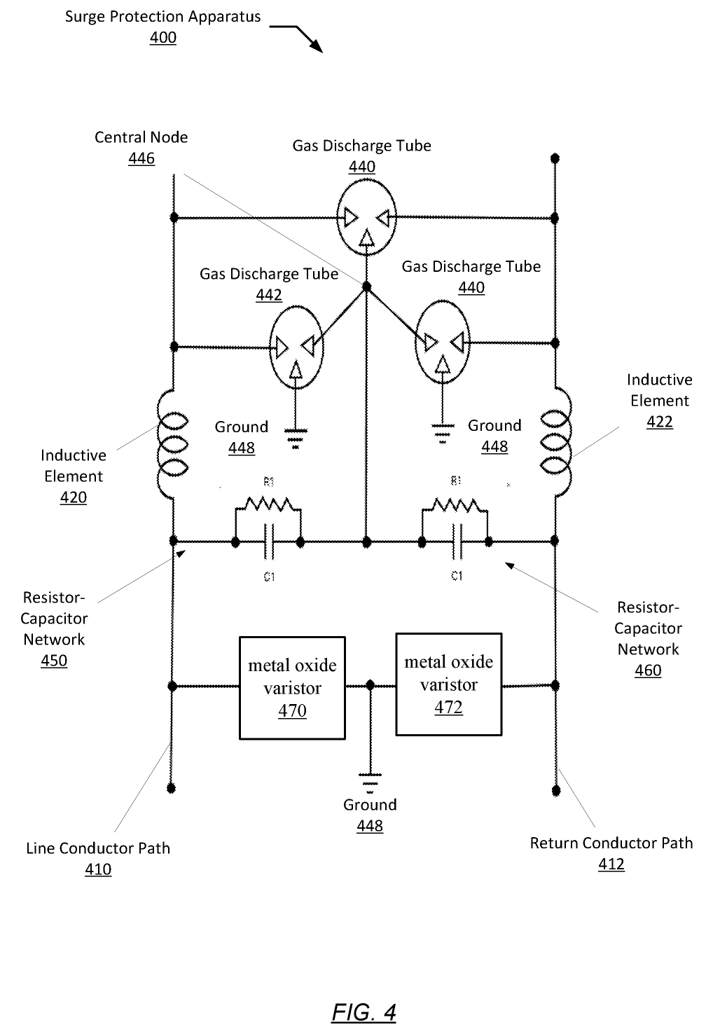

Referring now to FIG. 4, a surge protection apparatus (400) is shown in schematic form. The surge protection apparatus (400) may be coupled between an input side and an output side of a protected circuit and may include a line conductor path (410) and a return conductor path (412). In the illustrated embodiment, the apparatus (400) includes a first gas discharge tube (440), a second gas discharge tube (442), and a third gas discharge tube (444) arranged relative to a central node (446), together with inductive elements, resistor-capacitor trigger networks, and multiple metal oxide varistors. FIG. 4 may therefore represent a further embodiment of the multi-gas-tube topology in which both conductor-to-conductor and conductor-to-ground surge conditions are addressed within the same protection network.

The first gas discharge tube (440) is coupled to the line conductor path (410), the return conductor path (412), and the central node (446). The second gas discharge tube (442) is coupled to the line conductor path (410), the central node (446), and ground (448). The third gas discharge tube (444) is coupled to the return conductor path (412), the central node (446), and ground (448). With this arrangement, the first gas discharge tube (440) may provide a discharge path for a line-to-line surge condition, while the second gas discharge tube (442) and the third gas discharge tube (444) may provide discharge paths for respective line-to-ground surge conditions. The central node (446) interconnects the gas discharge tube network so that a transient developed at the central node (446) may influence conduction of multiple discharge devices.

A first inductive element (420) is disposed in the line conductor path (410), and a second inductive element (422) is disposed in the return conductor path (412). The inductive elements (420, 422) may be implemented as speed coils or other inductive devices configured to delay propagation of surge energy toward the protected side of the circuit. By delaying the leading edge of the surge current on the line conductor path (410) and the return conductor path (412), the inductive elements (420, 422) may permit a triggering condition to develop at the gas discharge tube network before the full surge current reaches downstream equipment.

A first resistor-capacitor network (450) is coupled between the line conductor path (410) and the central node (446), and a second resistor-capacitor network (460) is coupled between the return conductor path (412) and the central node (446). The resistor-capacitor networks (450, 460) may respond to a rapid voltage excursion on either conductor path and may develop a transient voltage at the central node (446). The transient voltage at the central node (446) may place one or more of the gas discharge tubes (440, 442, 444) into a condition for earlier conduction during a surge event.

A first metal oxide varistor (470) is coupled between the line conductor path (410) and ground (448), and a second metal oxide varistor (472) is coupled between the return conductor path (412) and ground (448). The first metal oxide varistor (470) and the second metal oxide varistor (472) may provide clamping paths for conductor-to-ground surge conditions.

During operation, a surge appearing on the line conductor path (410), the return conductor path (412), or both may be delayed by the inductive elements (420, 422) while one or both of the resistor-capacitor networks (450, 460) develop a transient at the central node (446). For a line-to-line surge condition, the third metal oxide varistor (480) and the first gas discharge tube (440) may cooperate to conduct surge current between the line conductor path (410) and the return conductor path (412). For a line-to-ground surge condition on the line conductor path (410), the first metal oxide varistor (470) and the second gas discharge tube (442) may provide protection relative to ground (448). For a line-to-ground surge condition on the return conductor path (412), the second metal oxide varistor (472) and the third gas discharge tube (444) may provide protection relative to ground (448).

The arrangement shown in FIG. 4 may therefore provide coordinated surge suppression for differential-mode and common-mode events. Lower-magnitude or repetitive surge events may be handled by one or more of the metal oxide varistors (470, 472, 480), while higher-energy events may also activate one or more of the gas discharge tubes (440, 442, 444). By combining the delayed surge propagation provided by the inductive elements (420, 422), the transient development at the central node (446), and the multiple available discharge paths, the apparatus (400) may reduce the voltage presented to the protected circuit under a range of surge conditions.

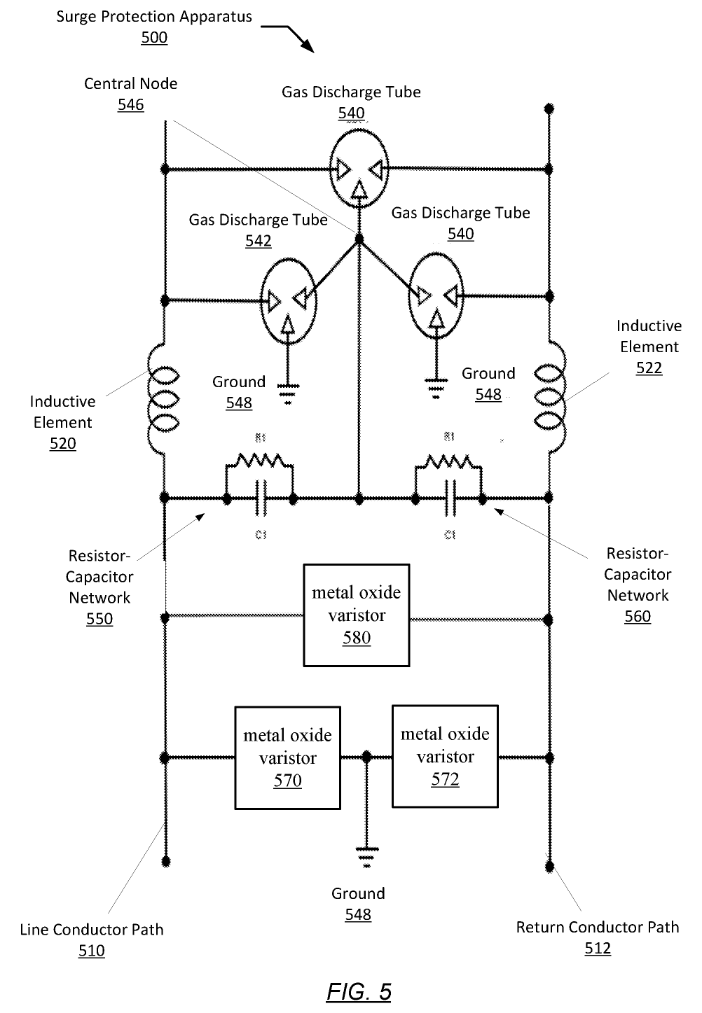

Referring now to FIG. 5, a surge protection apparatus (500) is shown in schematic form. The surge protection apparatus (500) may include a line conductor path (510), a return conductor path (512), a first gas discharge tube (540), a second gas discharge tube (542), a third gas discharge tube (544), a central node (546), a first inductive element (520), a second inductive element (522), a first resistor-capacitor network (550), a second resistor-capacitor network (560), a first metal oxide varistor (570), a second metal oxide varistor (572), and a third metal oxide varistor (580). FIG. 5 may generally correspond to the arrangement of FIG. 4, except that FIG. 5 further includes the third metal oxide varistor (580) coupled between the line conductor path (510) and the return conductor path (512).

The first gas discharge tube (540), the second gas discharge tube (542), and the third gas discharge tube (544) may be arranged relative to the central node (546) in a manner similar to FIG. 4. The first gas discharge tube (540) may be coupled to the line conductor path (510), the return conductor path (512), and the central node (546). The second gas discharge tube (542) may be coupled to the line conductor path (510), the central node (546), and ground (548). The third gas discharge tube (544) may be coupled to the return conductor path (512), the central node (546), and ground (548). With this arrangement, the gas discharge tubes (540, 542, 544) may provide discharge paths for line-to-line and line-to-ground surge conditions.

The first inductive element (520) may be disposed in the line conductor path (510), and the second inductive element (522) may be disposed in the return conductor path (512). The inductive elements (520, 522) may delay propagation of surge energy toward a protected side of the circuit. The first resistor-capacitor network (550) may be coupled between the line conductor path (510) and the central node (546), and the second resistor-capacitor network (560) may be coupled between the return conductor path (512) and the central node (546). In response to a surge event, the resistor-capacitor networks (550, 560) may develop a transient voltage at the central node (546) before a main surge current fully propagates through the conductor paths (510, 512).

The first metal oxide varistor (570) may be coupled between the line conductor path (510) and ground (548), and the second metal oxide varistor (572) may be coupled between the return conductor path (512) and ground (548). The third metal oxide varistor (580) may be coupled directly between the line conductor path (510) and the return conductor path (512). In this arrangement, the first metal oxide varistor (570) and the second metal oxide varistor (572) may provide clamping paths for line-to-ground surge conditions, while the third metal oxide varistor (580) may provide a clamping path for a line-to-line surge condition between the conductor paths (510, 512).

During operation, a surge event appearing on the line conductor path (510), the return conductor path (512), or both may be delayed by the inductive elements (520, 522) while the resistor-capacitor networks (550, 560) develop a transient at the central node (546). For a line-to-line surge, the third metal oxide varistor (580) may begin conducting across the conductor paths (510, 512), and the first gas discharge tube (540) may also conduct through the central node (546). For a line-to-ground surge on the line conductor path (510), the first metal oxide varistor (570) and the second gas discharge tube (542) may provide surge suppression relative to ground (548). For a line-to-ground surge on the return conductor path (512), the second metal oxide varistor (572) and the third gas discharge tube (544) may provide surge suppression relative to ground (548).

The arrangement of FIG. 5 may therefore provide coordinated surge suppression for differential-mode and common-mode surge events. Lower-magnitude or repetitive surges may be clamped by one or more of the metal oxide varistors (570, 572, 580), while larger surge events may additionally activate one or more of the gas discharge tubes (540, 542, 544). The added third metal oxide varistor (580) may increase the available suppression capability for surge energy appearing directly between the line conductor path (510) and the return conductor path (512), while the gas discharge tube network remains available to conduct higher-energy surge current.

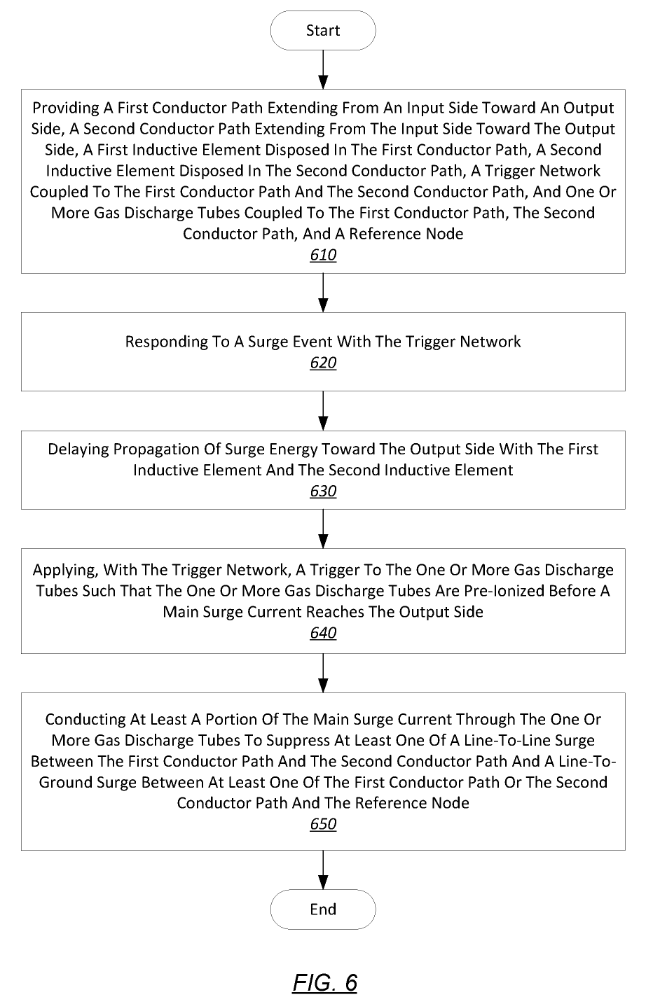

Referring now to FIG. 6, a method (600) of surge protection is shown. The method (600) may be performed using a surge protection apparatus having a first conductor path, a second conductor path, a first inductive element disposed in the first conductor path, a second inductive element disposed in the second conductor path, a trigger network coupled to the first conductor path and the second conductor path, and one or more gas discharge tubes coupled to the first conductor path, the second conductor path, and a reference node. The method (600) may be used to suppress surge conditions associated with an electrical load, including line-to-line surge conditions and line-to-ground surge conditions.

In step (610), the method includes providing the first conductor path extending from an input side toward an output side, the second conductor path extending from the input side toward the output side, the first inductive element disposed in the first conductor path, the second inductive element disposed in the second conductor path, the trigger network coupled to the first conductor path and the second conductor path, and the one or more gas discharge tubes coupled to the first conductor path, the second conductor path, and the reference node. This step establishes a surge suppression architecture in which incoming surge energy may travel along the conductor paths while the inductive elements and trigger network cooperate to prepare a discharge path before a main surge current reaches the protected side of the circuit.

The first conductor path and the second conductor path may correspond to line and return paths that carry operating current during normal use. The one or more gas discharge tubes may be coupled to provide a discharge path between the conductor paths, between either conductor path and the reference node, or both. In some embodiments, the reference node may be associated with a floating reference arrangement such that neither conductor path is permanently tied to ground at the load.

In step (620), the method includes responding to a surge event with the trigger network. The trigger network may detect a rapid voltage change or other transient condition appearing on one or both of the conductor paths. In some embodiments, the trigger network may include a first trigger coil associated with the first conductor path and a second trigger coil associated with the second conductor path so that a surge event on either conductor path may initiate a triggering response.

The trigger network may also include one or more capacitive and inductive coupling elements, a transformer arrangement, a spark gap, or combinations thereof. The triggering response may therefore be initiated by a rapid transient excursion rather than by waiting for the full surge current to propagate to the protected side of the circuit.

In step (630), the method includes delaying propagation of surge energy toward the output side with the first inductive element and the second inductive element. The inductive elements may be configured as speed coils or other inductive devices that impede the leading edge of the transient current. This delayed propagation creates a time interval in which the trigger network can act before the main surge current reaches the protected load.

The delay provided by the inductive elements may be present on both conductor paths so that the protection scheme is not limited to a surge arriving on only one side of the circuit. In this manner, the method may address surge events that appear differentially between the conductor paths as well as surge events that appear relative to the reference node.

In step (640), the method includes applying, with the trigger network, a trigger to the one or more gas discharge tubes such that the one or more gas discharge tubes are pre-ionized before a main surge current reaches the output side. The trigger may be generated in response to the detected transient condition and may be communicated to the one or more gas discharge tubes through a coupling arrangement that places the gas discharge medium in a condition for earlier conduction. Pre-ionization of the gas discharge tubes may reduce the delay otherwise associated with initiating gas-tube conduction during a fast-rising surge event.

In some embodiments, the trigger may be developed through capacitive coupling and a transformer arrangement and may include discharge across a spark gap. In other embodiments, the trigger may be developed at a central node coupled to multiple gas discharge tubes so that more than one discharge path is made available in advance of the main surge current.

In step (650), the method includes conducting at least a portion of the main surge current through the one or more gas discharge tubes to suppress at least one of a line-to-line surge between the first conductor path and the second conductor path and a line-to-ground surge between at least one of the first conductor path or the second conductor path and the reference node. Once the gas discharge tubes are pre-ionized, the tubes may conduct surge current more readily when the delayed main surge current reaches the discharge path. This may reduce the voltage presented to the output side and thereby reduce stress on the protected load.

Where multiple discharge devices are present, one gas discharge tube may conduct for a line-to-line surge condition while one or more additional gas discharge tubes may conduct for line-to-ground surge conditions. In some embodiments, one or more metal oxide varistors may also be present and may conduct lower-magnitude or repetitive surge events, while the gas discharge tubes conduct larger surge events in parallel with the metal oxide varistors. The steps shown in FIG. 6 may be performed in the illustrated order, although variations in order, overlap in execution, or repetition of selected steps may be used in other embodiments.

In view of the foregoing, the present disclosure provides surge protection apparatuses, systems, and methods in which surge energy arriving on one or more conductor paths is managed by coordinating inductive delay, triggered gas discharge conduction, and, in some embodiments, varistor-based suppression. The disclosed subject matter may be implemented with line and return conductor paths extending between an input side and an output side, with one or more inductive elements disposed in the conductor paths to delay propagation of surge energy, and with one or more gas discharge tubes arranged to conduct surge current before excessive voltage is presented to a protected load. In this manner, the disclosed arrangements may be used to suppress transient conditions associated with lightning events, switching events, and other overvoltage disturbances in circuits supplying radios, communications equipment, network equipment, and other electrical loads.

In some embodiments, a trigger network coupled to the conductor paths may respond to a surge event and apply a trigger to one or more gas discharge tubes so that the gas discharge tubes are pre-ionized before a main surge current reaches the protected side of the circuit. The trigger network may include one or more trigger coils, capacitive elements, spark gaps, transformer arrangements, resistor-capacitor networks, central nodes, or other coupling structures. The one or more gas discharge tubes may be arranged to conduct for line-to-line surge conditions, line-to-ground surge conditions, or both. The disclosed arrangements may further be configured for floating-ground environments in which neither conductor is permanently tied to ground at the protected load.

In further embodiments, one or more metal oxide varistors may be provided in parallel with one or more gas discharge tubes so that different suppression devices address different surge conditions or surge magnitudes. Multiple gas discharge tubes may be coupled relative to line, return, central-node, and ground locations, and multiple metal oxide varistors may be coupled between line and ground, return and ground, and line and return. The disclosed subject matter therefore encompasses a range of surge protection topologies in which delayed surge propagation, triggered gas discharge conduction, and coordinated suppression paths may be selected, combined, omitted, repeated, or otherwise arranged to suit a desired installation, grounding condition, or protection objective.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, “or” is an “inclusive or” and, as such includes “and.” Further, items joined by an or may include any combination of the items with any number of each item unless expressly stated otherwise.

The figures of the disclosure show diagrams of embodiments that are in accordance with the disclosure. The embodiments of the figures may be combined and may include or be included within the features and embodiments described in the other figures of the application. The features and elements of the figures are, individually and as a combination, improvements to the technology of keyword extraction using tags and n-grams. The various elements, systems, components, and steps shown in the figures may be omitted, repeated, combined, and/or altered as shown from the figures. Accordingly, the scope of the present disclosure should not be considered limited to the specific arrangements shown in the figures.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. A surge protection apparatus for protecting an electrical load, the apparatus comprising:
a first conductor path extending from an input side toward an output side;
a second conductor path extending from the input side toward the output side;
a first inductive element disposed in the first conductor path;
a second inductive element disposed in the second conductor path;
a trigger network coupled to the first conductor path and the second conductor path and configured to respond to a surge event; and
one or more gas discharge tubes coupled to the first conductor path, the second conductor path, and a reference node;
wherein the first inductive element and the second inductive element are configured to delay propagation of surge energy toward the output side, and
wherein the trigger network is configured to apply a trigger to the one or more gas discharge tubes such that the one or more gas discharge tubes are pre-ionized before a main surge current reaches the output side.

2. The apparatus of claim 1, wherein the trigger network comprises a first trigger coil associated with the first conductor path and a second trigger coil associated with the second conductor path.

3. The apparatus of claim 2, wherein the first inductive element and the second inductive element each have a greater inductance than the first trigger coil and the second trigger coil.

4. The apparatus of claim 1, wherein the trigger network further comprises a spark gap and a transformer arrangement configured to communicate the trigger to the one or more gas discharge tubes.

5. The apparatus of claim 4, wherein the transformer arrangement comprises a first transformer and a second transformer arranged to accommodate opposite surge polarities on the first conductor path and the second conductor path.

6. The apparatus of claim 1, wherein the one or more gas discharge tubes comprise a first gas discharge tube and a second gas discharge tube arranged on opposite sides of the reference node.

7. The apparatus of claim 1, wherein the reference node is part of a floating-ground configuration such that neither the first conductor path nor the second conductor path is permanently tied to ground at the electrical load.

8. The apparatus of claim 1, further comprising:
one or more metal oxide varistors coupled to the first conductor path and the second conductor path;
wherein the one or more metal oxide varistors are configured to conduct smaller surge events, and the one or more gas discharge tubes are configured to conduct larger surge events in parallel with the one or more metal oxide varistors.

9. The apparatus of claim 4, wherein the trigger network comprises a capacitor in series with a primary winding of the transformer arrangement.

10. The apparatus of claim 1, wherein the apparatus is configured to divert surge current in both a common-mode condition and a differential-mode condition.

11. A method of surge protection for an electrical load, the method comprising:
providing a first conductor path extending from an input side toward an output side, a second conductor path extending from the input side toward the output side, a first inductive element disposed in the first conductor path, a second inductive element disposed in the second conductor path, a trigger network coupled to the first conductor path and the second conductor path, and one or more gas discharge tubes coupled to the first conductor path, the second conductor path, and a reference node;
responding to a surge event with the trigger network;
delaying propagation of surge energy toward the output side with the first inductive element and the second inductive element;
applying, with the trigger network, a trigger to the one or more gas discharge tubes such that the one or more gas discharge tubes are pre-ionized before a main surge current reaches the output side; and
conducting at least a portion of the main surge current through the one or more gas discharge tubes to suppress at least one of a line-to-line surge between the first conductor path and the second conductor path and a line-to-ground surge between at least one of the first conductor path or the second conductor path and the reference node.

12. The method of claim 11, wherein responding to the surge event comprises detecting the surge event with a first trigger coil associated with the first conductor path and a second trigger coil associated with the second conductor path.

13. The method of claim 11, wherein applying the trigger to the one or more gas discharge tubes comprises coupling surge energy through a capacitor and a transformer arrangement and producing a discharge across a spark gap.

14. The method of claim 11, wherein delaying propagation of surge energy comprises routing surge current through a speed coil having a greater inductance than a trigger coil used to respond to the surge event.

15. The method of claim 11, further comprising conducting smaller repetitive surge events through one or more metal oxide varistors and conducting larger surge events through the one or more gas discharge tubes in parallel with the one or more metal oxide varistors.

16. A surge protection apparatus comprising:
a line conductor path extending between an input and an output;
a return conductor path extending between the input and the output;
a first gas discharge tube coupled to the line conductor path, the return conductor path, and a central node;
a second gas discharge tube coupled to the line conductor path, the central node, and ground;
a third gas discharge tube coupled to the return conductor path, the central node, and ground;
a first inductive element disposed in the line conductor path;
a second inductive element disposed in the return conductor path;
a first resistor-capacitor network coupled between the line conductor path and the central node;
a second resistor-capacitor network coupled between the return conductor path and the central node;
a first metal oxide varistor coupled between the line conductor path and ground; and
a second metal oxide varistor coupled between the return conductor path and ground;
wherein the first resistor-capacitor network and the second resistor-capacitor network are configured to develop a transient voltage at the central node in response to a surge event, and
wherein the first gas discharge tube, the second gas discharge tube, and the third gas discharge tube are configured to conduct surge current from at least one of the line conductor path and the return conductor path in line-to-line and line-to-ground surge conditions.

17. The apparatus of claim 16, wherein the first gas discharge tube is configured to conduct surge current between the line conductor path and the return conductor path through the central node.

18. The apparatus of claim 16, wherein the first inductive element and the second inductive element are configured to delay propagation of surge energy toward the output relative to development of the transient voltage at the central node.

19. The apparatus of claim 16, further comprising a third metal oxide varistor coupled between the line conductor path and the return conductor path.

20. The apparatus of claim 19, wherein the first metal oxide varistor, the second metal oxide varistor, and the third metal oxide varistor cooperate with the first gas discharge tube, the second gas discharge tube, and the third gas discharge tube to provide surge suppression for differential-mode and common-mode surge events.
